(19) United States
(12) Patent Application Publication
(10) Pub. No.: US 2015/0137744 A1
(43) Pub. Date: May 21, 2015

(54) TRANSMITTER APPARATUS OF WIRELESS POWER TRANSMISSION SYSTEM FOR CHARGING VEHICLE

(71) Applicant: Hyundai Motor Company, Seoul (KR)

(72) Inventors: Hee Jin LEE, Suseong-gu (KR); Chae Mo YANG, Gunpo-si (KR)

(21) Appl. No.: 14/328,431

(22) Filed: Jul. 10, 2014

(30) Foreign Application Priority Data
Nov. 15, 2013 (KR) 10-2013-0139424

(51) Int. Cl. B60L 11/18

(52) U.S. Cl. CPC B60L 11/182; B60L 11/1825
USPC 320/108

(57) ABSTRACT

A transmitter apparatus of a wireless power transmission system for charging a vehicle includes a parking stopper configured to be fixedly mounted on a ground of a parking space. A transmitter is configured to be connected to the parking stopper and to include a transmitter coil which generates a magnetic field at the time of parking the vehicle.

### CROSS REFERENCE TO RELATED APPLICATION

This application claims the benefit of priority to Korean Patent Application No. 10-2013-0139424, filed on Nov. 15, 2013, the entire contents of which is hereby incorporated by reference in its entirety into this application.

### TECHNICAL FIELD

The present disclosure relates to a transmitter apparatus of a wireless power transmission system for charging a vehicle, and more particularly, to a technology of configuring a transmitter apparatus of a wireless power transmission system using a parking stopper used at the time of parking a vehicle.

### BACKGROUND

An eco-friendly vehicle (electric vehicle, hybrid electric vehicle, and the like), which uses an electric motor as a driving source, is provided with a battery, in which the battery is charged by a plug-in charging method, a quick charging method, and the like which generally perform charging through a wire.

Recently, a technology of charging a high voltage battery of a vehicle using a wireless power transmission system has been developed. The wireless power transmission technology is developed to be free from a wire and may be classified into a magnetic induction type, a magnetic resonance type, and an electromagnetic wave type. A magnetic induction technology uses a non-radiation characteristic and a non-resonator and uses an electromagnetic induction principle which allows a receiver coil to induce electricity depending on a magnetic field generated from a power transmitter coil.

FIG. 1 illustrates a technology of charging a battery of a vehicle using the magnetic induction type among the wireless power transmission systems. According to the technology, when a vehicle 1 is positioned on a charging space, a transmitter coil 2 mounted on a ground generates a magnetic field, a receiver coil 3 mounted at a lower portion of a vehicle body generates electricity depending on the generated magnetic field, and the generated electricity is charged in a battery 4 in the vehicle.

One of the most important factors which allows the wireless power transmission technology using the magnetic induction type to determine power transmission efficiency is a distance between the transmitter coil 2 and the receiver coil 3. However, as illustrated in FIG. 1, the charging technology according to the related art has distance L1 between the transmitter coil 2 and the receiver coil 3 is relatively long since the transmitter coil 2 is fixedly mounted on the ground.

To solve the above problem, a technology of elevating the transmitter coil mounted on the ground or a technology of elevating the receiver coil mounted in the vehicle body has been used. However, all the technologies require a separate lift apparatus for elevating the coils, which causes increase of cost and complication of a configuration.

The matters described as the related art have been provided only for assisting in the understanding for the background of the present disclosure and should not be considered as corresponding to the related art known to those skilled in the art.

### SUMMARY

The present disclosure has been made in an effort to provide a transmitter apparatus for a wireless power transmission system for charging a vehicle configured using a parking stopper used at the time of parking the vehicle to be able to maximally reduce a distance between a transmitter coil and a receiver coil, thereby improving charging efficiency.

Further, the present disclosure has been made in an effort to provide a transmitter apparatus for a wireless power transmission system for charging a vehicle configured to improve charging efficiency without elevating a transmitter coil or a receiver coil, a separate lift apparatus is not necessary, thereby reducing cost and simplifying a configuration.

According to an exemplary embodiment of the present disclosure, a transmitter apparatus of a wireless power transmission system for charging a vehicle is provided. The apparatus includes a parking stopper configured to be fixedly mounted on a ground of a parking space. A transmitter is configured to be connected to the parking stopper and to include a transmitter coil which generates a magnetic field at the time of parking the vehicle.

The transmitter apparatus of a wireless power transmission system for charging a vehicle may further include a vehicle detection sensor configured to detect the vehicle entering the parking space.

The transmitter apparatus of a wireless power transmission system for charging a vehicle may further include a power supplier configured to supply a current to the transmitter coil. A controller is configured to receive a signal of the vehicle detection sensor to control an operation of the power supplier.

The transmitter may protrude backward of the parking stopper.

The transmitter may protrude forward of the parking stopper.

The transmitter may be disposed at the same height as the parking stopper and the transmitter coil may be mounted on the transmitter so that a distance between the transmitter coil and a receiver coil mounted in the vehicle is minimized.

The vehicle detection sensor may be integrally mounted on a front surface of the parking stopper which contacts a tire of the vehicle at the time of parking the vehicle.

The vehicle detection sensor may be fixedly mounted on the ground in front of the parking stopper.

The vehicle detection sensor may be a pressure sensor or a photo sensor.

According to another exemplary embodiment of the present disclosure, a transmitter apparatus of a wireless power transmission system for charging a vehicle includes a parking stopper configured to be fixedly mounted on a ground of a parking space. A transmitter coil is configured to be integrally mounted in the parking stopper to generate a magnetic field at the time of parking the vehicle.

The transmitter apparatus of a wireless power transmission system for charging a vehicle may further include a vehicle detection sensor configured to detect the vehicle entering the parking space.

The transmitter apparatus of a wireless power transmission system for charging a vehicle may further include a power supplier configured to supply a current to the transmitter coil A controller is configured to receive a signal of the vehicle detection sensor to control an operation of the power supplier.

The transmitter coil may be mounted on the parking stopper so that a distance between the transmitter coil and a receiver coil mounted in the vehicle is minimized.

The vehicle detection sensor may be integrally mounted on a front surface of the parking stopper which contacts a tire of the vehicle at the time of parking the vehicle.

The vehicle detection sensor may be fixedly mounted on the ground in front of the parking stopper.

The vehicle detection sensor may be a pressure sensor or a photo sensor.

### BRIEF DESCRIPTION OF THE DRAWINGS

The above and other objects, features and advantages of the present disclosure will be more clearly understood from the following detailed description taken in conjunction with the accompanying drawings.

FIG. 1 is a diagram for describing wireless power transmission using a magnetic induction type according to the related art.

FIG. 2 is a diagram for describing a wireless power transmission technology according to an exemplary embodiment of the present disclosure.

FIGS. 3 and 4 are diagrams for describing a transmitter of a wireless power transmission system according to an exemplary embodiment of the present disclosure.

FIG. 5 is a diagram for describing a transmitter of a wireless power transmission system according to another exemplary embodiment of the present disclosure.

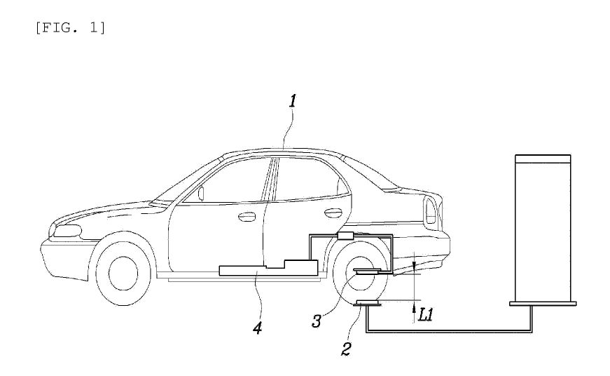

### DETAILED DESCRIPTION

Hereinafter, a transmitter apparatus of a wireless power transmission system for charging a vehicle according to exemplary embodiments of the present disclosure will be described with reference to the accompanying drawings.

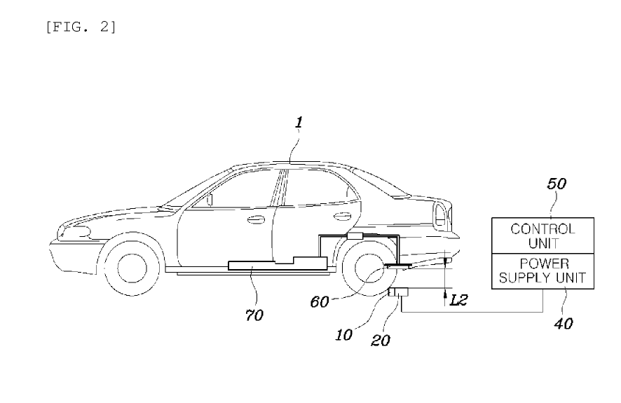

As illustrated in FIGS. 2 to 4, a transmitter apparatus for a wireless power transmission system for charging a vehicle according to an exemplary embodiment of the present disclosure includes a parking stopper 10 which is fixedly mounted on the ground of a parking space. A transmitter 20 is connected to the parking stopper 10 and includes a transmitter coil 21 generating a magnetic field at the time of parking a vehicle 1. A vehicle detection sensor 30 detects the vehicle entering the parking space. A power supplier 40 supplies a current to the transmitter coil 21. A controller 50 receives a signal of the vehicle detection sensor 30 to control an operation of the power supplier 40.

In this configuration, as illustrated, two parking stoppers 10 may be mounted to be spaced from each other in a horizontal direction, and if necessary, one or a plurality of parking stoppers may be mounted.

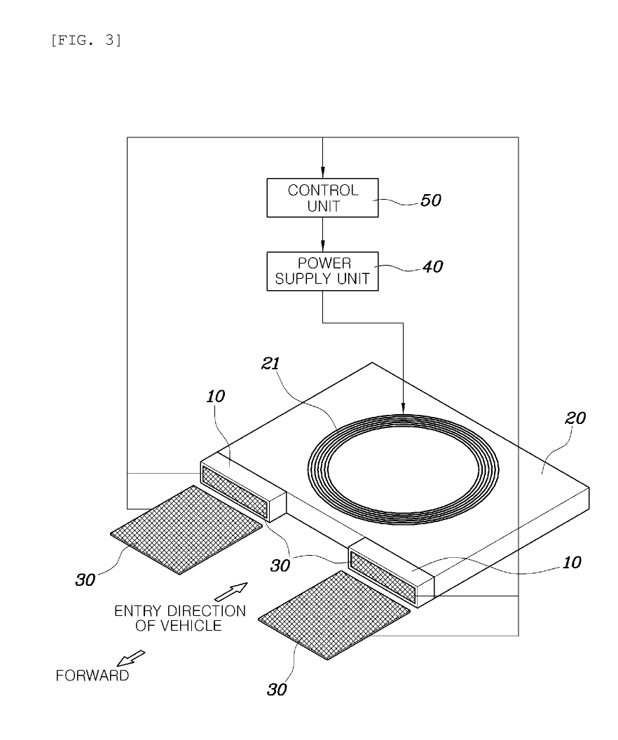

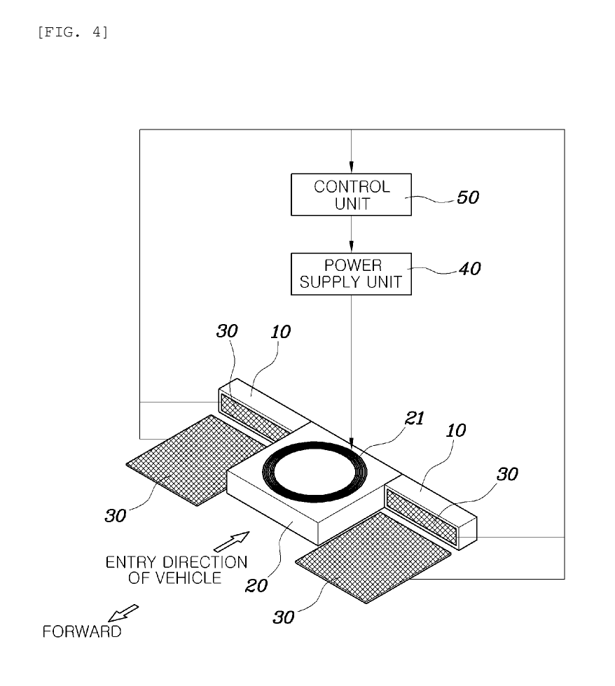

The transmitter 20 may protrude backward of the parking stopper 10 as illustrated in FIG. 3 or protrude forward of the parking stopper 10 as illustrated in FIG. 4. The transmitter 20 may be disposed at the same height as the parking stopper 10 to avoid an interference with a vehicle body at the time of parking the vehicle in consideration of a distance between a lower portion of the vehicle body and the ground regardless of a vehicle model. Further, the transmitter coil 21 may be mounted on the transmitter 20 so that a distance L2 between the transmitter coil 21 and the receiver coil 60 mounted in the vehicle may be minimized.

The vehicle detection sensor 30 may be configured of a pressure sensor, a photo sensor, or the like. As illustrated in FIG. 3, it may be integrally mounted on a front surface of the parking stopper 10 which contacts a tire of the vehicle at the time of parking the vehicle, or as illustrated in FIG. 4, it may be fixedly mounted on the ground in front of the parking stopper 10 in an entering direction of the vehicle at the time of parking the vehicle.

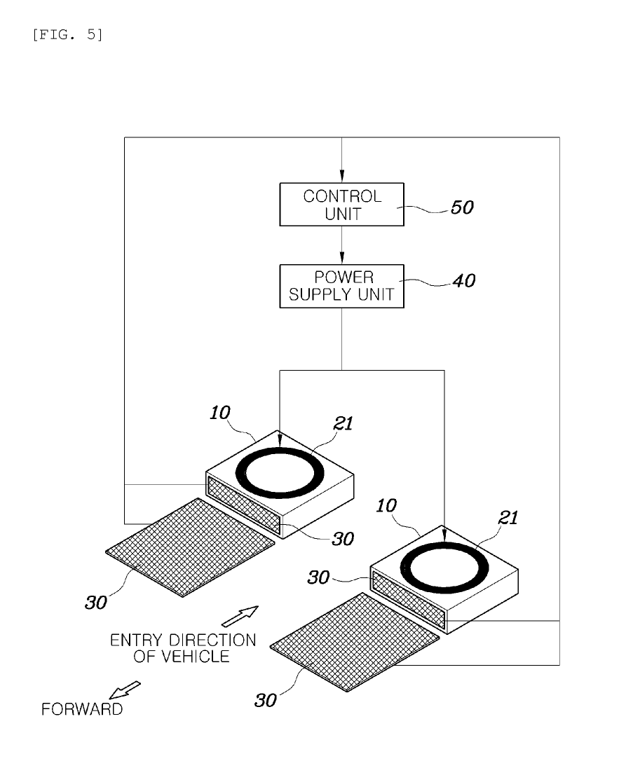

As illustrated in FIG. 5, a transmitter apparatus of a wireless power transmission system for charging a vehicle according to another exemplary embodiment of the present disclosure has a configuration in which the transmitter coil 21 is integrally mounted in the parking stopper 10. That is, since the transmitter apparatus of a wireless power transmission system for charging a vehicle illustrated in FIG. 5 has a configuration in which the transmitter coil 21 is integrally mounted in the parking stopper 10, the transmitter 20 illustrated in FIGS. 3 and 4 may be removed. The vehicle detection sensor 30, the power supplier 40 which supplies a current to the transmitter coil 21, and the controller 50 are the same as those of the transmitter apparatus of a wireless power transmission system for charging a vehicle illustrated in FIGS. 2 to 4, and therefore, the description thereof will be omitted.

As described above, when the transmitter coil 21 is mounted in the parking stopper 10, the transmitter coil 21 is mounted on the parking stopper 10, so that the distance L2 between the transmitter coil 21 and the receiver coil 60 mounted in the vehicle may be minimized.

Hereinafter, an operation of the transmitter apparatus of a wireless power transmission system for charging a vehicle according to the exemplary embodiment of the present disclosure will be described.

When a vehicle 1 enters the parking space, the vehicle detection sensor 30 mounted on a floor of the parking space or the vehicle detection sensor 30 mounted in the parking stopper 10 detects the vehicle. In this case, a signal of the vehicle detection sensor 30 is transferred to the controller 50, and the controller 50 receives the signal of the vehicle detection sensor 30 to control the operation of the power supplier 40. Here, the transmitter coil 21 generates a magnetic field by the operation of the power supplier 40, the receiver coil 60 mounted at a lower portion of a vehicle body generates electricity depending on the generated magnetic field, and a battery 70 mounted in the vehicle is charged with the generated electricity.

Further, when the vehicle is charged and deviates from the parking space, the operation of the power supplier 40 ends by the control of the controller 50, such that the transmitter coil 21 does not generate the magnetic field any more.

According to the exemplary embodiment of the present disclosure as described above, the transmitter apparatus of a wireless power transmission system including the transmitter coil 21 uses the parking stopper 10 at the time of parking the vehicle to be able to maximally reduce the distance L2 between the transmitter coil 21 and the receiver coil 60 mounted in the vehicle body and improves the power transmission efficiency, thereby considerably improving charging efficiency.

Further, according to the exemplary embodiment of the present disclosure, the transmitter apparatus of a wireless power transmission system improves the charging efficiency of the vehicle battery 70 without elevating the transmitter coil 21 or the receiver coil 60, and thus, a separate lift apparatus is not necessary, thereby reducing cost and simplifying a configuration.

According to the exemplary embodiments of the present disclosure, the transmitter apparatus for a wireless power transmission system including the transmitter coil uses the parking stopper at the time of parking the vehicle to maximally reduce the distance between the transmitter coil and the receiver coil mounted in the vehicle body and to improve the power transmission efficiency, thereby considerably improving charging efficiency.

Although the present disclosure has been shown and described with respect to specific exemplary embodiments, it will be obvious to those skilled in the art that the present disclosure may be variously modified and altered without departing from the spirit and scope of the present disclosure as defined by the following claims.

What is claimed is:

1. A transmitter apparatus of a wireless power transmission system for charging a vehicle, the apparatus comprising:
a parking stopper configured to be fixedly mounted on a ground of a parking space; and
a transmitter configured to be connected to the parking stopper and to include a transmitter coil which generates a magnetic field at the time of parking the vehicle.

2. The transmitter apparatus according to claim 1, further comprising:
a vehicle detection sensor configured to detect the vehicle entering the parking space.

3. The transmitter apparatus according to claim 2, further comprising:
a power supplier configured to supply a current to the transmitter coil; and
a controller configured to receive a signal of the vehicle detection sensor to control an operation of the power supplier.

4. The transmitter apparatus according to claim 1, wherein the transmitter protrudes backward of the parking stopper.

5. The transmitter apparatus according to claim 1, wherein the transmitter protrudes forward of the parking stopper.

6. The transmitter apparatus according to claim 1, wherein the transmitter is disposed at the same height as the parking stopper, and
the transmitter coil is mounted on the transmitter so that a distance between the transmitter coil and a receiver coil mounted in the vehicle is minimized.

7. The transmitter apparatus according to claim 2, wherein the vehicle detection sensor is integrally mounted on a front surface of the parking stopper which contacts a tire of the vehicle at the time of parking the vehicle.

8. The transmitter apparatus according to claim 2, wherein the vehicle detection sensor is fixedly mounted on the ground in front of the parking stopper.

9. The transmitter apparatus according to claim 2, wherein the vehicle detection sensor is a pressure sensor or a photo sensor.

10. A transmitter apparatus of a wireless power transmission system for charging a vehicle, the apparatus comprising:
a parking stopper configured to be fixedly mounted on a ground of a parking space; and
a transmitter coil configured to be integrally mounted in the parking stopper to generate a magnetic field at the time of parking the vehicle.

11. The transmitter apparatus according to claim 10, further comprising:
a vehicle detection sensor configured to detect the vehicle entering the parking space.

12. The transmitter apparatus according to claim 10, further comprising:
a power supplier configured to supply a current to the transmitter coil; and
a controller configured to receive a signal of the vehicle detection sensor to control an operation of the power supplier.

13. The transmitter apparatus according to claim 10, wherein the transmitter coil is mounted on the parking stopper so that a distance between the transmitter coil and a receiver coil mounted in the vehicle is minimized.

14. The transmitter apparatus according to claim 11, wherein the vehicle detection sensor is integrally mounted on a front surface of the parking stopper which contacts a tire of the vehicle at the time of parking the vehicle.

15. The transmitter apparatus according to claim 11, wherein the vehicle detection sensor is fixedly mounted on the ground in front of the parking stopper.

16. The transmitter apparatus according to claim 11, wherein the vehicle detection sensor is a pressure sensor or a photo sensor.
